(19) United States
(12) Patent Application Publication
(10) Pub. No.: US 2014/0122123 A1
(43) Pub. Date: May 1, 2014

(54) Controlling Access to Medical Records

(71) Applicant: Intellirad Solutions Pty Ltd., East Hawthorn (AU)

(72) Inventor: Robert Hofstetter, Carlton (AU)

(73) Assignee: Intellirad Solutions Pty Ltd., East Hawthorn (AU)

(21) Appl. No.: 14/032,641

(22) Filed: Sep. 20, 2013

Related U.S. Application Data
(63) Continuation of application No. 13/553,106, filed on Jul. 19, 2012, now abandoned.
Application No. 13/553,106 is a continuation of application No. 10/557,178, filed on Oct. 9, 2006, now abandoned.

(30) Foreign Application Priority Data
May 19, 2003 (AU) 2003902423

(51) Int. Cl. G06F 19/00

(52) U.S. Cl. CPC G06F 19/322
USPC 705/3

(57) ABSTRACT

A method for controlling the access of healthcare providers to the medical records of a patient held in a medical record database. A patient controls the access of the healthcare providers to the patient's medical records held in a medical record database. The patient determines access rights to be granted to the healthcare provider and generates an access authorization message which specifies the access rights. The access authorization message is transmitted from the patient to one or more healthcare providers. The healthcare provider transmits the access authorization together with a request for access to the patient's medical records to the medical record database. The medical record database verifies that the access authorization message originated from the patient before granting the healthcare provider access to the patient's medical records in accordance with the access authorization message.

### FIELD OF THE INVENTION

The present invention relates generally to methods and systems for managing access to medical records held in a medical record database. More particularly, the invention relates to a method and system whereby a patient can control the access of healthcare providers to his or her personal medical records.

### BACKGROUND TO THE INVENTION

Patient medical records including information such as medical history, diagnostic images, diagnostic test results or reports are often stored in digital form on medical record databases which may be accessed by healthcare professionals who are involved in treatment of patients. Examples of such medical record databases may be Picture Archiving and Communication Systems (PACS), Pathology Information Systems, Radiology Information Systems, Electronic Patient Record Systems, or the like, or any combination of these.

Medical record databases typically do not provide sufficient transparency to the patient regarding who can access and modify the patient's medical records. Medical record databases usually grant access upon entry of a username/password combination that is assigned to each healthcare provider. Medical record databases often implement relatively complicated access policies and authentication methods, whilst still granting a large number of medical professionals unnecessary access to patient medical records. The group of healthcare providers that have access to a patient's medical records is normally much larger than the group of healthcare providers who are involved in the patient's treatment. With each individual who has unnecessary access to a patient's medical records, the risk of data abuse or unauthorized access increases. Therefore the privacy of the patient is severely compromised.

It has been suggested that a nationwide or worldwide patient record database could be beneficial for patient treatment, by permitting a patient's medical history, prior diagnostic results, as well as diagnostic images to be made available to any treating medical professional. Access to this information could support healthcare providers in making decisions which will benefit the patient. However provision of a nationwide or worldwide patient record database would grant access to thousands of medical professionals and healthcare providing organizations to each patient's personal medical records. Preventing unauthorized access to private information becomes very difficult.

### SUMMARY OF THE INVENTION

According to a first aspect of the present invention, there is provided a method for controlling the access of healthcare providers to the medical records of a patient held in a medical record database, the method including the steps of:

(a) the patient determining access rights to be granted to one or more healthcare providers;
(b) generating an access authorisation message which specifies the access rights;
(c) transmitting the access authorisation message from the patient to one or more healthcare providers;
(d) transmitting the access authorisation message together with a request for access to the patient's medical records from the healthcare provider to the medical record database;
(e) verifying that the access authorisation message originated from the patient;

wherein the healthcare provider is granted access to the patient's medical records in accordance with the access authorisation message if it can be verified that the access authorisation message originated from the patient whose medical records the health provider wishes to access.

In a preferred embodiment of the invention, the verification that the access authorisation message originates from the patient involves authenticating a digital signature accompanying the access authorisation message. Preferably, the digital signature is generated by a private encryption key associated with the patient and the medical record database authenticates the digital signature using a public decryption key which corresponds to the private encryption key.

In one form of the invention, the access rights determined by the patient are entered into a personal electronic device via an associated user interface and the personal electronic device generates the corresponding access authorisation message for transmission to the healthcare provider. The personal electronic device may include a private encryption key associated with the patient which is used to generate the digital signature which accompanies the access authorisation message.

The access authorisation message may include any one or more of the following restrictions:

(a) a time interval during which access is authorised;
(b) a category of medical data to which access is authorised; or
(c) a type of access which is authorised.

Preferably, the medical record database is accessible to healthcare providers over a network.

The access authorisation message may further include an identifier corresponding to the healthcare provider to whom access is granted by the patient.

In an alternative embodiment of the present invention, the personal electronic device is password protected. According to yet another alternative embodiment, the personal electronic device is activated using one or more forms of biometric data associated with the patient.

In one particular embodiment of the invention, the medical record database verifies that the access authorisation message originated from the patient using a password transmitted by the patient to the healthcare provider together with the access authorisation message.

According to a second aspect of the present invention, there is provided a system for controlling the access of healthcare providers to the medical records of a patient held in a medical record database, the system including:

(a) an input component for entering patient determined access rights to be granted to one or more healthcare providers;
(b) a processor for generating an access authorisation message that specifies the access rights;
(c) a first transmitter for transmitting the access authorisation message from the patient to one or more healthcare providers;
(d) a second transmitter for transmitting the access authorisation message together with a request for access to the patient's medical records from the healthcare provider to the medical record database;
(e) a verification component for verifying that the access authorisation message originated from the patient;

wherein the healthcare provider is granted access to the patient's medical records in accordance with the access authorisation message if it can be verified that the access authorisation message originated from the patient whose medical records the health provider wishes to access.

Preferably, the verification component verifies that the access authorisation message originates from the patient by authenticating a digital signature accompanying the access authorisation message.

The processor may be provided as part of a personal electronic device selected from one of the following:

(a) smart card;
(b) mobile telephone; or
(c) personal digital assistant.

Preferably, the input component is a user interface associated with the personal electronic device.

In a preferred embodiment of the present invention, the processor stores a private encryption key associated with the patient, the private encryption key being used to generate the digital signature and the verification component authenticates the digital signature using a public decryption key which corresponds to the private encryption key.

The medical record database is preferably accessible to healthcare providers over a network.

In one alternative form of the invention, the personal electronic device is password protected. In another form, the personal electronic device is activated using one or more forms of biometric data associated with the patient.

It is an advantage of the present invention that patients can control access to their personal medical records. Patients can grant and revoke access and also grant access to selected data only or for a limited interval of time.

It is a further advantage of the present invention that facilitating patient control over personal medical records is likely to lead to greater public acceptance of mass electronic storage of personal medical records by giving patients confidence that only those medical professionals directly involved in the patient's treatment will have access to his or her medical history, diagnostic test results, diagnostic images, etc.

### BRIEF DESCRIPTION OF THE DRAWINGS

The invention will now be described in further detail by reference to the attached drawings illustrating example forms of the invention. It is to be understood that the particularity of the drawings does not supersede the generality of the preceding description of the invention. In the drawings:

FIG. 1 is a schematic diagram showing the data flow between system components in accordance with an embodiment of the present invention.

FIG. 2 is a flow chart showing the access restriction and authentication process in accordance with an embodiment of the present invention.

### DETAILED DESCRIPTION

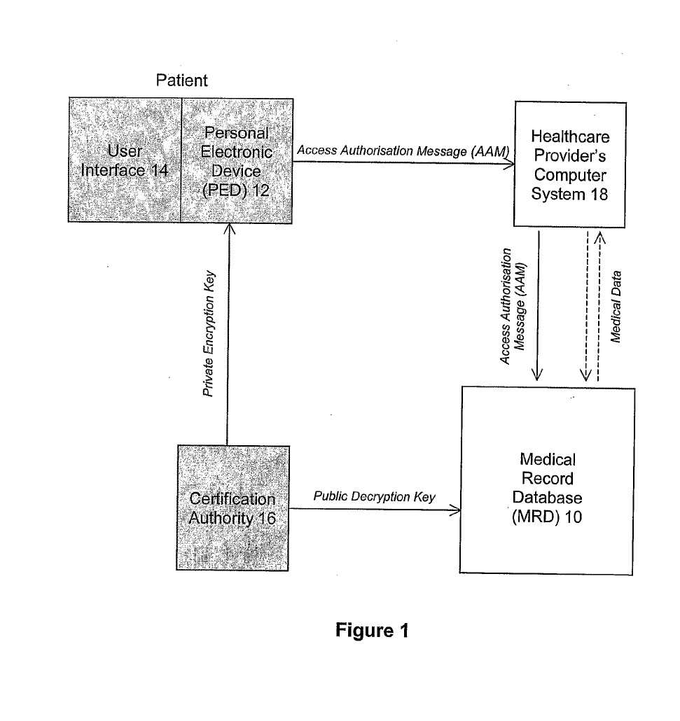

Referring firstly to FIG. 1, any healthcare provider such as a doctor, dentist, surgeon, chiropractor, physiotherapist or other medical professional may be granted access to a medical record database 10. The medical record database 10 could be a corporate wide, nation wide or worldwide medical record database and is provided on a network which is readily accessible to healthcare providers, such as the Internet. Patients are enabled to control the access of healthcare providers to their personal medical records by specifying access rights and issuing them to those healthcare providers that are involved in the patient's treatment.

The patient's medical records that are held on the medical record database 10 may include data such as medical history, diagnostic test results such as blood tests and pathology reports and diagnostic images such as radiographs. The patient can determine the extent of access to be provided to healthcare providers on the basis of what data is pertinent to the treatment that the patient is currently seeking. For example, a chiropractor would not necessarily need to know that a patient is HIV positive. This enables the patient to have direct control as to by whom and when his or her private medical records will be accessed.

The access rights that may be specified by the patient may include restrictions relating to a time interval for which access is granted, for example, for the month of May 2004. In addition, or alternately, the patient may be concerned about the type of data that can be accessed by healthcare providers. For instance, the patient may wish to grant access only to those diagnostic test results which are pertinent to current treatment and not those relating to other complaints which are not relevant to the current treatment regime. Furthermore, the patient may be prepared to grant a number of healthcare providers read only access to his or her personal medical records but only wishes to grant write access to a select number of healthcare providers.

These and other specifications and/or restrictions applied to access rights are entered by the patient into a personal electronic device 12 via a user interface 14 which may be integrated into the personal electronic device 12 or may be an external device provided by the healthcare provider. The personal electronic device 12 is an electronic device which is owned by or made available to the patient. Examples of suitable personal electronic devices 12 include chip cards such as smart cards, mobile telephones and personal digital assistants. The personal electronic device must provide sufficient memory and processing capacity to execute commands which are stored in its memory.

Ideally, all patients would be issued with a healthcare card including a chip capable of storing and processing data relating to access rights. The data could be entered via a dedicated chip card reader provided by the healthcare provider and the healthcare card could be carried by the patient at all times in case of emergency. In this example, the user interface via which access rights may be specified would be a keypad associated with the dedicated card reader.

Once the patient's determinations for access rights have been entered into the personal electronic device 12 via a user interface 14, the personal electronic device's processing capacity is employed to generate a corresponding access authorisation message which specifies the access rights which the patient intends to grant to the healthcare provider.

The access authorisation message further includes a digital signature for authentication purposes. A private encryption key based on public key infrastructure (PKI) issued to the patient by a Certification Authority 16 is used to generate the digital signature. The private encryption key is stored on the personal electronic device for this purpose.

The access authorisation message is transmitted from the patient to the healthcare provider together with the digital signature. Transmission to the healthcare provider may occur via the personal electronic device 12, for example by mobile telephone or could be transmitted using a personal digital assistant or via email directly to the healthcare provider's computer system 18. The healthcare provider receives the access authorisation message and transmits a request for access to the patient's medical records to the medical record database 10 together with the access authorisation message received from the patient. The medical record database 10 may be accessible to the healthcare provider via a network such as the Internet in the case of a global or nationwide medical record database or alternatively could be accessible via a local area network (LAN) or other wide area network (WAN) in the case of an organisation specific medical record database.

The medical record database 10 receives the request for access together with the access authorisation message and verifies that the access authorisation message originated from the patient whose medical records the healthcare provider wishes to access. Where the access authorisation message includes a digital signature generated by a private encryption key issued by a Certification Authority 16, the medical record database 10 will authenticate the origin of the access authorisation message using a public decryption key which corresponds to the private encryption key used to generate the digital signature. If the access authorisation message can be authenticated as originating from the patient, then access will be granted to the healthcare provider in accordance with the access policy provided by the patient. If the digital signature cannot be verified, access to the patient's medical records is denied.

The access authorisation message may include an identifier that corresponds to a healthcare provider to whom the patient has granted access rights. If the access authorisation message includes such an identifier, only the healthcare provider corresponding to the identifier will be granted access to the patient's records. This feature is particularly applicable where the patient wishes to grant exclusive access rights to a single healthcare provider.

As an alternative to the verification process described, it is envisaged that for patients that are less technology savvy, a similar effect could be achieved by the patient issuing the healthcare provider with an alphanumeric string or password. The alphanumeric string or password could be derived from the Certification Authority in much the same way that the patient obtains a private encryption key from the Certification Authority. This may entail the Certification Authority issuing the patient with a number of alphanumeric strings or passwords to accompany access authorisation messages specifying different access scenarios. The alphanumeric string or password could be transmitted to the healthcare provider in written form or verbally to overcome the problem of patients who do not have access to personal electronic devices such as mobile telephones and personal digital assistants. This method will of course provide the patient with somewhat less flexibility and security than association of the digital signature with the access authorisation message.

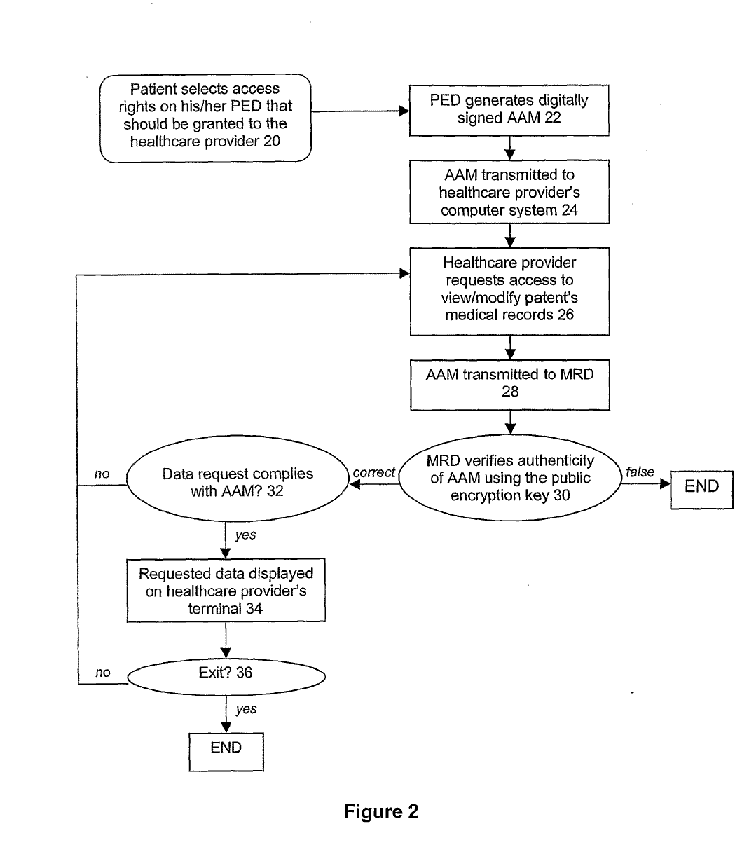

Referring now to FIG. 2, the patient performs the following steps to grant a healthcare provider access to the patient's personal medical records. The patient determines what type of data the patient wishes to permit the healthcare provider to view, add to or modify 20. The patient also determines the period of time the data will be accessible to the healthcare provider. The patient's determinations are entered into the personal electronic device via a user interface.

The personal electronic device internally generates a creates a message that containing patient identification data, access limitations (e.g. ‘read only/write only’ or ‘diagnostic images only’), and access time limits which have been determined by the patient 22. This message is the access authorization message and has a standardized format. For example, an access authorisation message could be issued by patient X to grant read and write access to all of patient X's diagnostic images for the next two days.

The personal electronic device adds a digital signature to the access authorisation message. The digital signature is based on a private encryption key based on public key infrastructure (PKI). The private encryption key is stored permanently in the memory of the personal electronic device and cannot be directly accessed from outside the personal electronic device. The private encryption key can be integrated with the personal electronic device at the time of manufacture (e.g. for smart cards), or could be transmitted through a secure, encrypted data connection using dependable patient authentication (e.g. for mobile telephones or personal digital assistants). In the event that a personal electronic device is lost or stolen, the Certification Authority can issue a new private encryption key and corresponding public decryption key and transmit the private encryption key to a new electronic device by suitable means. Unauthorised data access using the stolen personal electronic device is therefore negated.

The digital signature is used to verify that the access authorisation message has been issued by the patient's personal electronic device and ensures that the access authorisation message is not modified after issuing. The digitally signed access authorisation message is transmitted from the patient's personal electronic device to the healthcare professional's computer system 24. The access authorisation message may be transmitted via a public or wireless network in an encrypted form, or via a direct connection in case of a smart card inserted into a dedicated smart card reader made available by the healthcare provider.

The access authorisation message is stored on the healthcare provider's computer system. It is sent to the medical record database when the healthcare provider wants to access, modify or add medical data to the patient's existing medical record 26. In case of data transfer through a public network such as the Internet, communication between the healthcare provider and the medical record database must be in a secure, encrypted form to prevent unauthorised access to the access authorisation method. The access authorisation method is transmitted either with every transaction request, or at the beginning of a data connection or session 28.

The medical record database has access to the public decryption key which corresponds to the personal encryption key issued to the patient by a Certification Authority and stored on the patient's personal electronic device. The medical record databases uses the public decryption key to verify the digital signature accompanying the access authorisation message 30. If the digital signature can be decoded with the public decryption key, it is evident that the access authorisation message was issued with the patient's personal electronic device.

The healthcare provider requests to view or modify data in the patient's medical record held in the medical record database or may request to add medical data to the patient's medical record. The medical record database verifies that the data request or data submission complies with the access rights granted in the access authorisation message 32. In accordance with the access rights granted in the access authorisation message, the medical record database delivers or accepts and modifies data in the patient's medical record as requested or provided by the healthcare provider 34.

When the time limit specified in the access authorisation message has expired any further request for access will be denied. This prevents reuse of the access authorisation message by unauthorised users in the event that an access authorisation message is obtained in an unauthorised manner and also prevents abuse of access rights to patient medical records once treatment is complete.

A single access authorisation message may be issued to more than one, healthcare provider. Therefore, Doctor A can email Doctor B to obtain a second opinion on a patient's diagnosis. Doctor B can use the same access authorisation message as Doctor A to access the patient's diagnostic test reports contained in the patient's medical record held in the medical record database.

Additional measures to improve security against unauthorised use of the patient's personal electronic device to can access to personal medical records if the device is lost or stolen, include using a personal identification number (PIN) or password known only to the patient. In this case, the personal electronic device will only issue an access authorisation message after the PIN or password has been entered.

Alternatively, requiring a scan of the patient's biometric data before issuing an access authorisation message can prevent unauthorized usage of the patient's personal electronic device to gain access to personal medical records. The biometric scan could be for example, a fingerprint. In this case, the personal electronic device does not issue an access authorisation message until a biometric scan has been performed and verified as matching the biometric data stored on the personal electronic device. The advantage of a biometric scan such as a fingerprint scan over password or PIN protected measures, is that is that an access authorisation message can be issued when even if the patient is unconscious in case of an emergency.

In contrast to known systems used to control access to patient records, in accordance with the present invention access to the medical record database is not based on usernames and passwords issued to healthcare providers. Therefore, there is no need for the medical record database to store identification data relating to healthcare providers or to authenticate the identity of those healthcare providers requesting access to a particular patient's medical records. Instead, the medical record database verifies whether the patient has genuinely granted access to the healthcare provider to the patient's personal medical records, before any patient specific medical data is revealed or modified. Provided that the authenticity of the access authorisation message can be verified, at no stage, is it necessary for the healthcare providers to verify their own identity. This saves time and avoids unnecessary complications.

Implementation of the present invention could give confidence to patients that only those professionals directly involved in the patient's treatment are granted access to the patient's personal details including medical history, test results, and diagnostic images, etc. The patient is able to control access to personal medical records by means of limiting access to selected data, even for healthcare providers who are involved in the patient's treatment. Using the method and system outlined, the patient can control who is able to view or modify personal medical records and can limit access to those individuals and/or organizations that the patient trusts. This leads to enhanced privacy in large medical databases and will no doubt increase acceptance of mass storage of electronic medical data by the public

It is to be understood that various additions, alterations and/or modifications may be made to the parts previously described without departing from the ambit of the invention.

1-21. (canceled)

22. A computer-implemented method for controlling the access of healthcare providers to the medical records of a patient held in a medical record database, the method including the steps of:
(a) the patient inputting access rights to be granted to one or more healthcare providers into a personal electronic device via an associated user interface;
(b) the personal electronic device generating an access authorization message which identifies the one or more healthcare providers and specifies the corresponding access rights;
(c) transmitting the access authorization message from the personal electronic device to a computer system of one of the one or more healthcare providers;
(d) transmitting the access authorization message together with a request for access to a patient's medical records from the healthcare provider's computer system to the medical record database;
(e) verifying that the access authorization message originated from the patient;
wherein the healthcare provider is granted access to the patient's medical records in accordance with the access authorization message if it is verified that the access authorization message originated from the patient.

23. The method according to claim 22, wherein verifying that the access authorization message originated from the patient includes authenticating a digital signature associated with the access authorization message.

24. The method according to claim 23, wherein the digital signature is generated by a private encryption key associated with the patient and the medical record database authenticates the digital signature using a public decryption key which corresponds to the private encryption key.

25. The method according to claim 22, wherein the personal electronic device includes a private encryption key associated with the patient which is used to generate the digital signature that accompanies the access authorization message.

26. The method according to claim 22, wherein the access authorization message includes one or more of the following restrictions:
(a) a time interval during which access is authorized;
(b) a category of medical data to which access is authorized; or
(c) a type of access which is authorized.

27. The method according to claim 22, wherein the medical record database is accessible to the one or more healthcare providers over a network.

28. The method according to claim 22, wherein the personal electronic device is password protected.

29. The method according to claim 22, wherein the personal electronic device is activated using one or more forms of biometric data associated with the patient.

30. The method according to claim 22, wherein the medical record database verifies that the access authorization message originated from the patient using a password transmitted by the patient to the healthcare provider together with the access authorization message.

31. A system for controlling the access of healthcare providers to the medical records of a patient held in a medical record database, the system including:
(a) an input component for entering patient determined access rights to be granted to one or more healthcare providers;
(b) a processor for generating an access authorization message that identifies the one or more healthcare provides and specifies the corresponding access rights;
(c) a first transmitter for transmitting the access authorization message from the the processor to one or more healthcare providers;
(d) a second transmitter for transmitting the access authorization message together with a request for access to the patient's medical records from the healthcare provider to the medical record database;
(e) a verification component for verifying the that the access authorization message originated from the patient;
wherein the healthcare provider is granted access to the patient's medical records in accordance with the access authorization message if it is verified that the access authorization message originated from the patient whose medical records originated from the patient

32. The system according to claim 31, wherein the verification component verifies that the access authorization message originated from the patient by authenticating a digital signature associated with the access authorization message.

33. The system according to claim 31, wherein the processor is provided as part of a personal electronic device selected from one of the following:
(a) smart card;
(b) mobile telephone; or
(c) personal digital assistant.

34. The system according to claim 33, wherein the input component is a user interface associated with the personal electronic device.

35. The system according to claim 33, wherein the processor stores a private encryption key associated with the patient, the private encryption key being used to generate the digital signature and the verification component authenticates the digital signature using a public decryption key that corresponds to the private encryption key.

36. The system according to claim 31, wherein the medical record database is accessible to the one or more healthcare providers over a network.

37. The system according to claim 33, wherein the personal electronic device is password protected.

38. The system according to claim 33, wherein the personal electronic device is activated using one or more forms of biometric data associated with the patient.
